(19) United States
(12) Patent Application Publication
(10) Pub. No.: US 2019/0303138 A1
(43) Pub. Date: Oct. 3, 2019

(54) APPARATUS AND METHOD FOR VERSIONING, PACKAGING, MIGRATING AND COMPARING ARTIFACTS OF PACKAGED AND ENTERPRISE APPLICATIONS USING VIRTUAL FILE SYSTEMS

(71) Applicant: CA, Inc., Islandia, NY (US)

(72) Inventors: Peter Szulman, Baden (AT); Tobias Stanzel, Vienna (AT); Ron Gidron, Tel Aviv (IL)

(21) Appl. No.: 15/940,218

(22) Filed: Mar. 29, 2018

(51) Int. Cl. G06F 8/71; G06F 17/30

(52) U.S. Cl. CPC G06F 8/71; G06F 17/30126; G06F 17/30235

(57) ABSTRACT

Provided is a process of providing logical access between software development tools and stored content that is otherwise inaccessible to the software development tools, the process including: mounting a virtual file system to an underlying file system configured to store content on a mount point, wherein: the underlying file system configured to store content is accessible via the mount point, the underlying file system configured to store content has access to data modified by third party software; mapping, with one or more processors, the data to a plurality of files or a plurality of folders accessible with the virtual file system; and logically associating, with one or more processors, the files or folders with the data such that modification of the data in the underlying file system causes modification of at least one of the files or one of the folders accessible with the virtual file system.

### CROSS REFERENCE TO RELATED APPLICATIONS

This disclosure presents no cross-reference.

### BACKGROUND

### 1. Field

The present disclosure relates generally to managing a file system, and more particularly, to performing one or more file system operations on artifacts within enterprise software.

### 2. Description of the Related Art

Business entities often rely on enterprise software for a number of reasons ranging from human resources management to financial accountings to implementation of specific software for development and support of the businesses' own products and services. Frequently, this enterprise software is customized for use by the particular business. Large enterprises are reliant on their core enterprise systems where most of their data and business logic currently sit. Rapidly changing market requirements often force the enterprises to adapt their business processes, software, logic and data as quickly as possible. Responding to the market requirements in as agile a manner as possible becomes a key for success. These same enterprise systems may be unfit for agility and innovation as they may completely lack architecture and tooling support for sophisticated software management, including development and release within the business itself, and are structurally difficult to access through typical development tools.

Packaged enterprise applications need to be customized continuously (e.g., as frequently as every few minutes, hourly, daily, weekly, or monthly) to implement constantly evolving business logic of enterprises. The business logic as constructed is often a complex interplay of artifacts, where an artifact may include, but is not meant to be limited to (which is not to suggest other examples are limiting), a configuration item (e.g., user permission types, available country codes in an Enterprise Resource Planning system), business objects/components of the enterprise’ domain model, instance data (e.g. users, product catalogues, instance data in a database etc.), business process (e.g. sales process, customer management) etc. Artifact as used herein is not limited to the examples given but is specifically contemplated to include additional items such as code, matrices, setup scripts, and other byproducts of the software development process.

Artifacts of enterprise applications, thus, often change. Developers may implement business requirements in a first instance but also fix issues detected in production environments in a second instance. In case of packaged enterprise applications, the result of a feature implementation is manifested as a new artifact or changed version of an existing artifact. Changed artifacts may be packaged in order to more easily manage and propagate changes to subsequent environments.

Common tasks carried out on artifacts may include (but not limited to, which is not to suggest other examples are limiting) their development, versioning, packaging, backup, and restore as well as their propagation to subsequent environments. Best practices in versioning, packaging, and migrating frequently rely on customization and programming in a text-based language, and such practices often rely on access to the customized business software as files and folders within a file system.

### SUMMARY

Some embodiments provide a method and media for exposing customized enterprise software and artifacts associated therewith to the best practices of software development, and enhancing the efficiency and agility of software customization, versioning, packaging, and migrating through exposure of enterprise software artifacts to software development tools through a file and folder-capable virtual file system. The present invention includes methods and media directed toward an OS-native mounted virtual file system with files and folders corresponding to customizations of enterprise software and artifacts related thereto, accessible with and operable with development tools.

The following is a non-exhaustive listing of some aspects of the present techniques. These and other aspects are described in the following disclosure.

Some aspects include a method of providing logical access between software development tools and stored content that is otherwise inaccessible to the software development tools, the method comprising: mounting, with one or more processors, a virtual file system to an underlying file system configured to store content on a mount point, wherein the underlying file system configured to store content is accessible via the mount point, the underlying file system configured to store content has access to data created, edited, or otherwise modified by, using, or within third party software, and source code is not available for the third party software; mapping, with one or more processors, the data to a plurality of files or a plurality of folders accessible with the virtual file system; and logically associating, with one or more processors, the plurality of files or the plurality of folders with the data such that modification of the data in the underlying file system causes modification of at least one of the plurality of files or one of the plurality of folders accessible with the virtual file system.

Some aspects include a tangible, non-transitory, machine-readable medium storing instructions that when executed by a data processing apparatus cause the data processing apparatus to perform operations including the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is representation according to some embodiments disclosing a mounted virtual file system with access to a packaged enterprise application.

FIG. 2 is a representation according to some embodiments of this disclosure showing a user's access to various enterprise system environments

FIG. 3a is an exemplary display according to some embodiments of this disclosure for a user to view the underlying objects as files in a hierarchy of a virtual file system.

FIG. 3b is a second exemplary display according to some embodiments of this disclosure for a user to view the underlying objects as files in a hierarchy of a virtual file system, within the folders shown in the previous figure.

FIG. 4a is a representation of a software development cycle.

FIG. 4b is a representation of a software development cycle according to some embodiments of this disclosure wherein a virtual file system facilitates exposure of enterprise software customizations to development tools.

FIG. 5 is a representation of the virtual file system according to certain embodiments of this disclosure having access to the files of various exemplary enterprise software.

FIG. 6 is an example of a computing device upon which the present techniques may be implemented in accordance with some embodiments of the present techniques.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

In certain embodiments consistent with the techniques of this disclosure, a user employs enterprise software to create business-specific tools, datasets, and files and associated artifacts. This enterprise software is often third party software, such as enterprise applications purchased, leased, or otherwise acquired for use by a business, including certain Customer Relationship Management (CRM), Enterprise Resource Planning (ERP), Business Continuity Planning (BCP), HR Management, and Enterprise Application Integration (EAI) software and include products offered under various product names e.g., Peoplesoft, Siebel. These categories and instances of third party software are employed by certain businesses but not generally created by such business, and the business does not have access to the source code of the third party software. The data that is a product of the customization and implementation are often information created, edited, or modified using a visual (or text-based, human readable) programming language, and its associated artifacts (e.g., metadata that describes the first data). They are often stored in a format that is inconvenient to developers, that is, cannot be readily accessed and used by or with standard development software or development tools, or otherwise is not susceptible or to ready use under the best practices of software development, without the use of additional software or code separate from the enterprise software application. This inconvenient format can be any format that prevents the development tools from parsing, opening, accessing the data, or otherwise making it unable to be usable by the software development tool. Some embodiments expose the datasets and artifacts locked in packaged enterprise applications as files/folders via OS-native, virtual file system implementations. The semantics of mapping of artifacts and their relationships to files/folder may be implemented within the virtual file systems in some embodiments.

The techniques taught in this disclosure are applicable to a range of third party software, including compiled or interpreted versions of enterprise software encoded in byte code or native machine code (the native machine code is computer programming that is compiled to run with a particular processor and its set of instructions), and at times stored in a native file system. In certain embodiments, the byte code is programming code that, once compiled, is run through a virtual machine instead of the computer's processor. By using this approach, source code can be run on any platform once it has been compiled and run through the virtual machine.

To these ends and others, some embodiments afford a file structure of having actual file layer for customizing or employing enterprise software and creating actual files from the same, a virtual file layer of a plurality of virtual files mapped to the actual files, and a virtual file system root layer for managing the plurality of virtual files.

### 1. Virtual File System

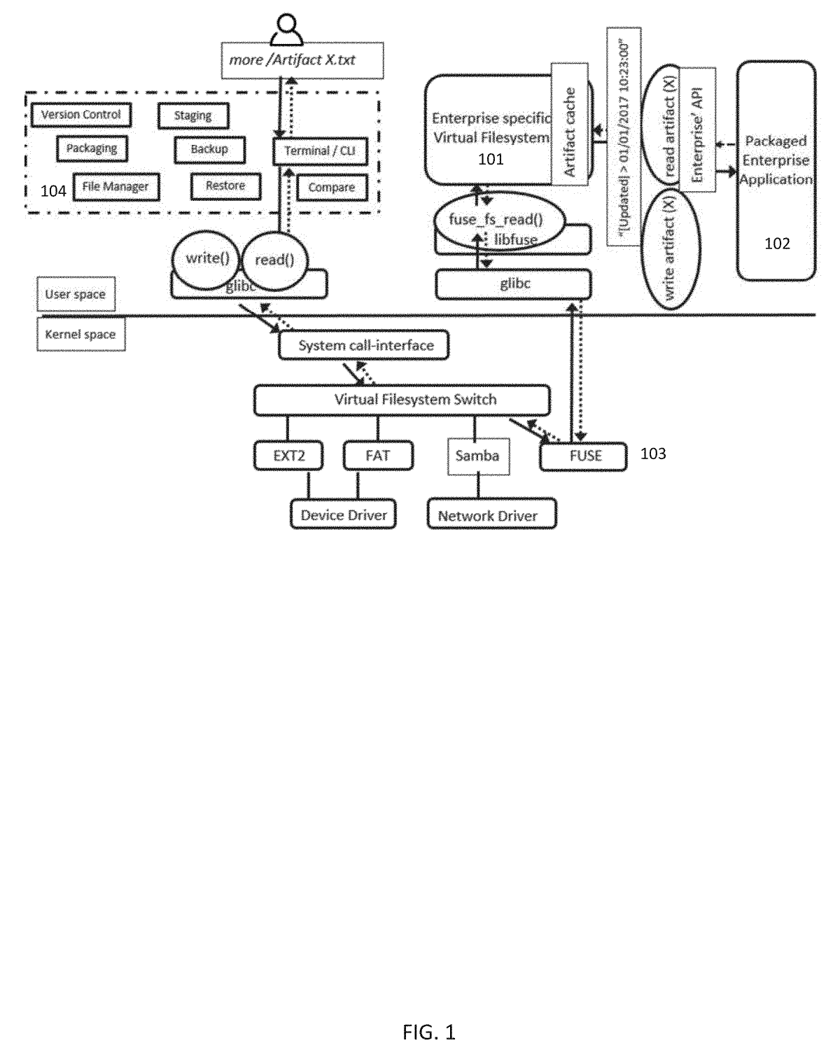

As shown in FIG. 1, the virtual file system 101 is logically connected to the enterprise software 101, which may be customized (relative to the form in which it is released by a developer, e.g., by entities without access to source code) pursuant to this disclosure. The virtual file system 102 may serve as an abstraction on top of the file system of the customized package of enterprise applications 101. In certain embodiments, the virtual file system implements an OS-native FUSE API 103 and by that is seamlessly accessible by file system based tools (e.g., is accessible via a native file system of an OS), shown in FIG. 1 as 104. A filesystem in FUSE can be created by, for instance, downloading FUSE source code from sources such as GitHub®, and unpacking the package, installing a FUSE kernel and using the FUSE library and API set to create the filesystem. Techniques such as those explained in a document titled Develop Your Own Filesystem with FUSE, S. Singh (Oct. 14, 2014) are applicable and this document is incorporated herein in its entirety. In some embodiments, the operating system employs other loadable kernel modules that allow users to create files without editing kernel code. In these embodiments, the filesystem maintains file-related metadata, an internal data structure that keeps all data organized and readily accessible, and associates metadata with the corresponding files. This virtual file system, in some embodiments, provides transparent access to the files to applications including the herein discussed software development tools. The virtual filesystem may be mounted on a mount point, such as a path (e.g., through a filesystem directory hierarchy) logically located inside the virtual filesystem that represents an in-use file system for the target enterprise software, which may be local or networked, and which has access to the customized enterprise software by one or more processors. This mount point in many embodiments is a directory (typically an empty one) in the filesystem of customized enterprise software on which the virtual filesystem of the present disclosure is mounted, that is, logically attached, such that resources mapped to the directory are accessible in program code by specifying the directory path and appending a file name/sub-directory. This technique of using a virtual filesystem mounts the different file systems in a uniform way relative to other resources typically accessed by locally executed code.

In certain systems, e.g., a Linux® system, the system call “mount( )” and “MountFS( )” may be employed and a directory may be used as a mount point. In certain embodiments, the general format of an entry within a virtual filesystem file comprises a physical path (e.g., a drive letter, a directory name or a shared directory on a networked machine), a virtual path (e.g., /tmp) which corresponds to an empty directory inside the virtual file system mount point, and an owner. Additionally, the general format will name permissions and other necessaries specific to the OS at issue.

The virtual filesystem in certain embodiments is mounted on a directory that serves as a mount point. On Linux®, UNIX®, and similar operating systems, filesystems on different partitions can be attached to a mount point in the directory tree, and detached again. To attach or detach the virtual file system, the user can employ the mount or umount command respectively.

In some embodiments, the virtual filesystem can, in user space programs, handle file system operations such as open, read, write, etc., in many embodiments. Through the techniques taught herein, the enterprise software continues to use its application-provided file system, and the virtual filesystem emulates physical storage. Changes to the files in a virtual files system are applied to real source files automatically.

In certain embodiments, the files and folders can be displayed to the user. Once the customized enterprise software and/or associated artifacts are accessible through a virtual file system, a user can utilize a graphical user interface (GUI) or a command line interface (CLI) to perform various file system operations (e.g., file management tasks) on the artifacts, now mapped as objects (e.g., files, folders) in the virtual file system. In this manner, the customized enterprise software and/or associated artifacts are displayed and accessible to the user. In general, the virtual file system can be located at a computer that the user is operating or on a remote computer accessible via a network (e.g., a file server), and can be accessed by various users or developers utilizing different integrated development environment tools. The user utilizes the interface (GUI or CLI) as necessary or desirable to browse the contents of the file system or to access its contents. To this extent, when the file system comprises a hierarchical file system, in which folders can include files and other folders, the interface can present the user a tree based on the hierarchical structure that can be used to navigate the folders and/or display files included in the folders. The stored content accessible through the virtual file system is the customization of the enterprise software specific for the business and the associated artifacts.

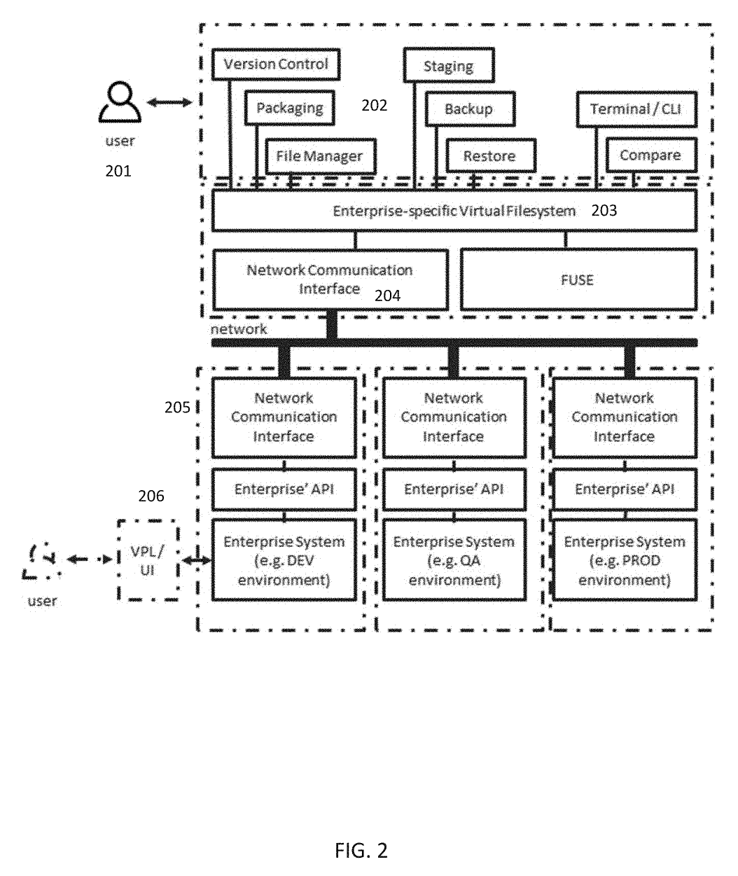

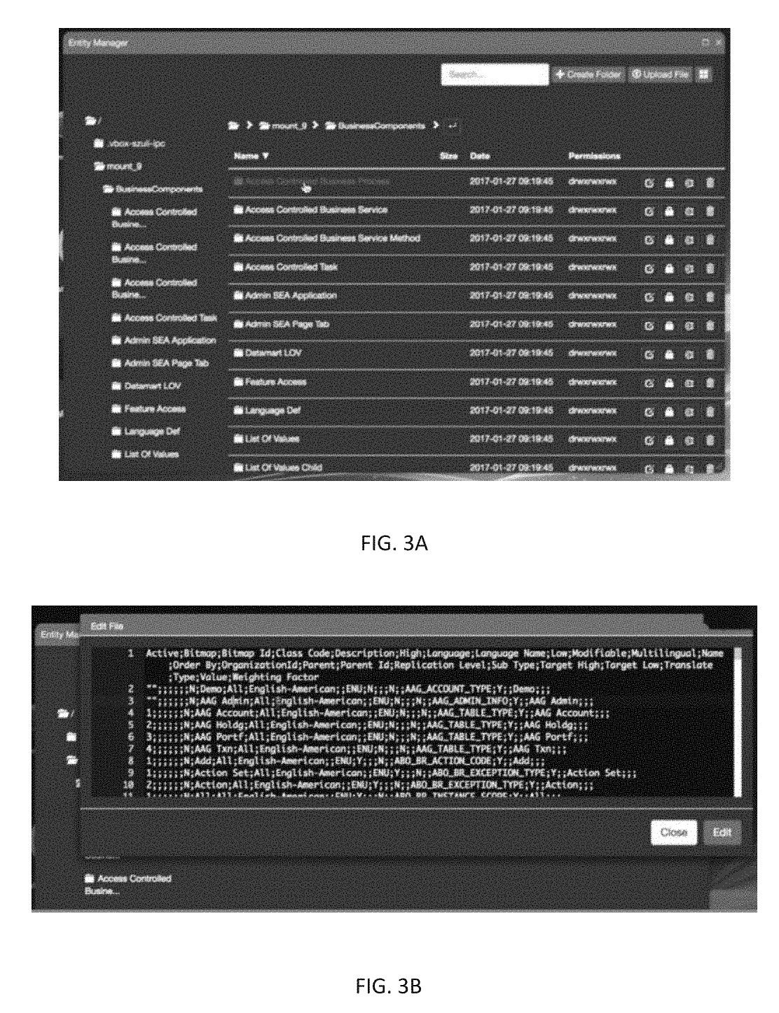

As shown in FIG. 2, in some embodiments, the resultant architecture allows a user 201 to utilize the suite of software development tools and processes 202 (e.g., version control tools, staging, packaging, etc.) through the virtual filesystem 203. Through the network communication interface 204, the user 201 can access the enterprise system 205 with the agile (and other) software development tools configured to operate upon resources stored and formatted for a native file system. This is expected to reduce the need for usage of visual programming languages 206, at times incompatible with the agile software development tools, to modify any customized enterprise software. FIGS. 3a and 3b show an example of a resultant display available to the user from using the virtual filesystem, wherein a hierarchical folder system is shown and the underlying files are editable customized artifacts within enterprise software. In this example, the underlying files are part of an underlying file system that is configured to store content and has access to data created, edited, or otherwise modified by, using, or within third party software.

In certain embodiments, the interface can facilitate searching to locate a desired object. For example, a search can be performed based on all or a portion of the name of the desired object(s), a text search can be performed to locate object(s) whose contents include the specified content, etc. Once a desired object in the file system has been located, in some embodiments, the user can utilize the interface to request the performance of one or more additional file system operations on the object.

In certain embodiments, files/folders are read, changed, created or deleted, and the mapped artifacts within the target customized enterprise software are read, changed, created or deleted. In certain embodiments, when the target customized enterprise software is read, changed, created, or deleted, files/folders within the virtual filesystem are likewise read, changed, created, or deleted. In certain embodiments, the changes are bi-directional. The objects, files, and artifacts of the enterprise software or business system are mapped to the virtual file system as files and folders. Because the virtual file system maps files and folders to the enterprise software or business system, when a new item is created in the system, it appears as a new file or folder in the virtual filesystem. Likewise, if a change is made to an existing file or folder in the virtual file system, then that change will trigger a change in the attached application, e.g., an item can be added to the system by editing a file in the file system. In certain embodiments, the creation of a file within the virtual file system will create a new object within the third party enterprise software. And correspondingly, in some embodiments, the inverse is true, the creation of a new object within the third party software creates a new file in the virtual filesystem. In each scenario of such embodiments, operations may create the new object and creates the new file without additional input from the user. By this manner, the virtual filesystem is bi-directional. Moreover, in certain embodiments, the files are associated with their artifacts, such that a modification of one file propagates to the associated artifact or artifacts, and in certain embodiments the reverse is accomplished wherein a modification to an artifact modifies the file.

In certain embodiments, the filesystem employed is native to the operating system. Known native file system include, for Linux, e.g., ext2, ext3, ext4, reiserFS, or for Mac OS includes HFS+, APFS, FAT32, exFAT. It is understood that a variety of filesystems are usable with the present disclosure (which is not to suggest that other descriptions are limiting).

In certain embodiments, any or all of the different data, filesystems, artifacts, processors, and memory is distributed among networked computers and do not reside in a single machine. The networked devices can intercommunicate through a variety of physical layer, network layer, transport layer, and application layer protocols.

In certain embodiments, various techniques for mapping an object created through customization of an enterprise software solution to a virtual filesystem can be employed. One such method includes fuzzing an interface of an enterprise application (e.g., by systematically or randomly supplying inputs and detecting changes to persistent or dynamic memory that result to create a mapping between inputs and changes in state) to identify where a dataset representing a particular customization of enterprise software resides in the enterprise software and to identify the bounds of that dataset. Or such mapping may be hand-coded. Other techniques usable in certain embodiments include adjusting a configuration of third party software and selecting portions of the data that change in response to that adjustment. Once the discovery of the dataset via fuzzing (or other process) is complete, that dataset can be associated (e.g., mapped) with a particular file or folder within the virtual file system.

### 2. Exposure to Application Life Cycle

Placing the artifacts in an accessible, searchable, and manipulable virtual file system is advantageous because it makes these artifacts accessible to many known development tools (e.g., Git™, Maven®, NPM®, Jenkins®) whose functionality assumes artifacts are available as files on a file system. Prior to associating it with the virtual file system in many instances, the underlying data is not accessible or intelligible to the software development tools. Some embodiments of the present techniques provide logical access between the software development tools and the stored content that is otherwise inaccessible to software development tools. The virtual file system exposes through file/folder format the applications and configurations of applications within the enterprise software to the typical process of application life cycle, and consequently to the types of programs used at each stage of the typical lifecycle, including those processes and programs that are considered best practices. Many known software development tools are created and used by developers on the assumption that the target of the development is in a file/folder format, which are intelligible to the software, that is, capable of being opened, run, edited, etc. by that software.

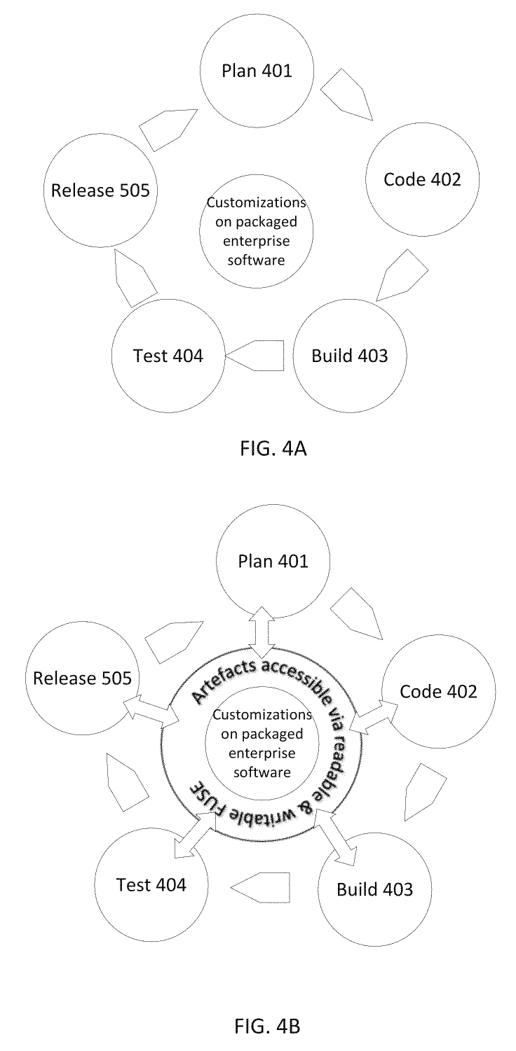

As shown in FIG. 4a, a lifecycle of an application can be understood to be plan 401→code 402→build 403→test 404→release 405→plan (repeated), there are a number of known tools used to aid developers at each stage of the lifecycle or in coordination with each stage of the lifecycle operable in text-based languages and/or operable on files/folders. The coding stage of the lifecycle is completed with and/or conducted in coordination with and/or relies upon, for example, IDEs, OS CLIs and versioning control. Integrated development environments (“IDE”) include e.g., NetBeans and Eclipse, and allow for programming in an integrated space despite utilizing separate computing devices including for example source code editors, compilers, and debuggers. The use of IDEs with target customized enterprise software allows the user more robust programming opportunities. Version control systems such as Git™ allow for and coordinate multiple people's near simultaneous and/or sequential update to software as a version control system for tracking changes in the software. The use of version control systems with target customized enterprise software allows for, among other things, identification of prior versions of the target customized enterprise software and relevant information related to the same, the ability to undo certain changes, and the ability to rollback to prior versions at the detection of an error. It also allows for distributed development among multiple users, branching of versions due to the same, identification and recapture of prior versions and re-merging of different branches. The use of Git™ is exemplary, and other version control tools are available. The building stage of development includes and/or is performed in coordination with software project management and comprehension tools, automation servers, and package managers. One such software project management and comprehension tool is Maven®. The software project management and comprehension tools allow for simple setup for development of a new project or module structured to follow best practices. Because of the uniformity of these project management tools, new developers can be brought into projects with little to no effort lost familiarizing themselves with the specifics of the project schema. Exposure of the target customized enterprise software to these software project management and comprehension tools allows customization to be done in a uniform and comprehensible fashion for multiple users, with the attendant benefits thereof. It is understood that software project management and comprehension tools other than Maven® are available and usable in certain embodiments.

Some embodiments render legacy enterprise software capable of interfacing with tools used in the application development phase, like automation servers. One such automation server is Jenkins®. The automation server helps to automate the non-human portion of the software development process and allows developers to reliably build, test, and deploy the software, and automate tasks related to the same. Other automation servers than Jenkins® can equally be used in certain embodiments. Package managers can also be used with the virtual filesystem's file/folder setup. One such package manager is NPM®. These package managers automates the process of installing, upgrading, configuring, and removing computer programs in a consistent manner. Exposing target customized enterprise software to package managers allows for the finding, installing, maintaining, and/or uninstalling customized enterprise software packages upon the user's command and in a uniform manner. A reader will understand that other package managers would be useful. By this method, the above-mentioned categories of software development tools, and those specific tools discussed, can access the files and folders of the virtual filesystem and the contents of the virtual system can be displayed within the user interface of the software development tool, and therefore the enterprise software customizations and business products created with same enterprise software can be accessed by the user, and the best practices for software development and internal software management by a company can be followed as shown in FIG. 4b.

Of interest in the software development cycle is version control, which manages the revisions and versions of software as various users in various different development environments develop and commit changes to the software and to specific portions thereof and allow access to previous versions of the software. Bugs and features of the software are worked on by different people in different locations. In typical customizations of enterprise software, agile development tools are not available and the version control is left to cumbersome processes. Some embodiments allows for agile version control software and techniques to be used with the enterprise customizations.

Of additional importance in maintenance of a software system within an enterprise setting is packaging. Utilization of the techniques taught herein can, in certain embodiments, solve for problems in packaging in enterprises. Packaging involves the preparation of standard, structured software installations targeted for automated deployment. Automated installations, or packages, meet the installation requirements for a specific environment: corporate standards for software usage and desktop design, multiple languages, regional issues, and software-related support issues. In addition, packages are prepared for both commercial software and applications developed in-house. The typical steps of a packaging process include Package request, Technical Evaluation of the Source, Packaging (capture, editing, testing), Quality Assurance (QA), and User Acceptance Testing (UAT). Without the techniques of this disclosure, as the enterprise software is modified and customized for use in enterprise applications, packaging practices are often not used or impossible, and documentation is rarely included in the modification. In such cases, no uniformity exists in presentation of source code and no overarching process for error checking exists. Without access the packaging tools available through the use of certain embodiments of the present invention, the enterprise software customization process is uncontrolled. In an uncontrolled environment, such as exists when the techniques taught herein are not implemented, the testing necessary to ensure that a new application will not cause a previous application to fail or become unusable can be difficult if not impossible across large enterprises. By implementing an application packaging strategy as discussed in this disclosure, in some embodiments, the process for installation, uninstallation, patches and repair can become uniform and an organization can reduce administrative costs while providing business benefits, including, for instance, enabling administrators to set and enforce corporate software configuration standards and to minimize the frequency of administrative errors during installation. With the target customizations exposed to the development tools in some embodiments, proper packaging is possible.

Readers of ordinary skill in the art will understand the above represents certain of the tools available under best practices for software development at present. Other tools and other best practices exist and are equally applicable with the present techniques. Moreover, the present techniques are equally usable as best practices and tools applicable to software development on objects stored in files and folders change, are modified, or are developed in the future. The specifically identified products and companies above are not the exclusive companies and are not the exclusive products relevant the present techniques, and additional companies and products currently exist that are usable in a like manner, and it is expected additional companies and products will be developed in the future that are equally employable to the techniques taught herein, none of which is to suggest that any other description is limiting.

The implementation of a virtual file system in certain embodiments can be done in any number of known languages or applications including, e.g., Java, Python, C++.

Existing file-based solutions can version, package/build, and stage files/folders. Some embodiments expose artifacts via file systems from the existing enterprise system that were previously locked in. By exposing these as file systems, versioning, packaging and mitigating between environments is done seamlessly. Textual representation of customizations is expected to allow increased efficiency relative to traditional approaches.

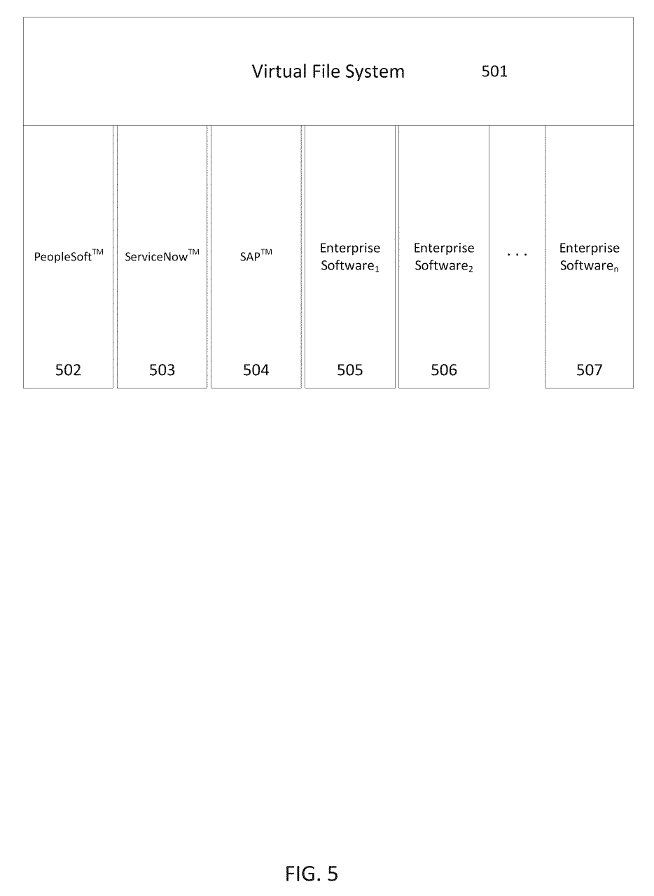

It will be understood that the techniques taught herein can be completed and implemented locally on a single device or in any number of computers and storage media networked, wherein any device, processor, logical code, or storage media performs any or all of the processes described herein, and can be accessed by any number of users. Each device can perform some or all of the steps or implement some or all of the media disclosed herein. As shown in FIG. 5, the virtual file system 501 can be implemented in such as to be an abstraction layer above multiple different enterprise software, exemplaries shown as 502-507, in such a way as to allow transparent access to the software beneath and provide the advantages discussed herein.

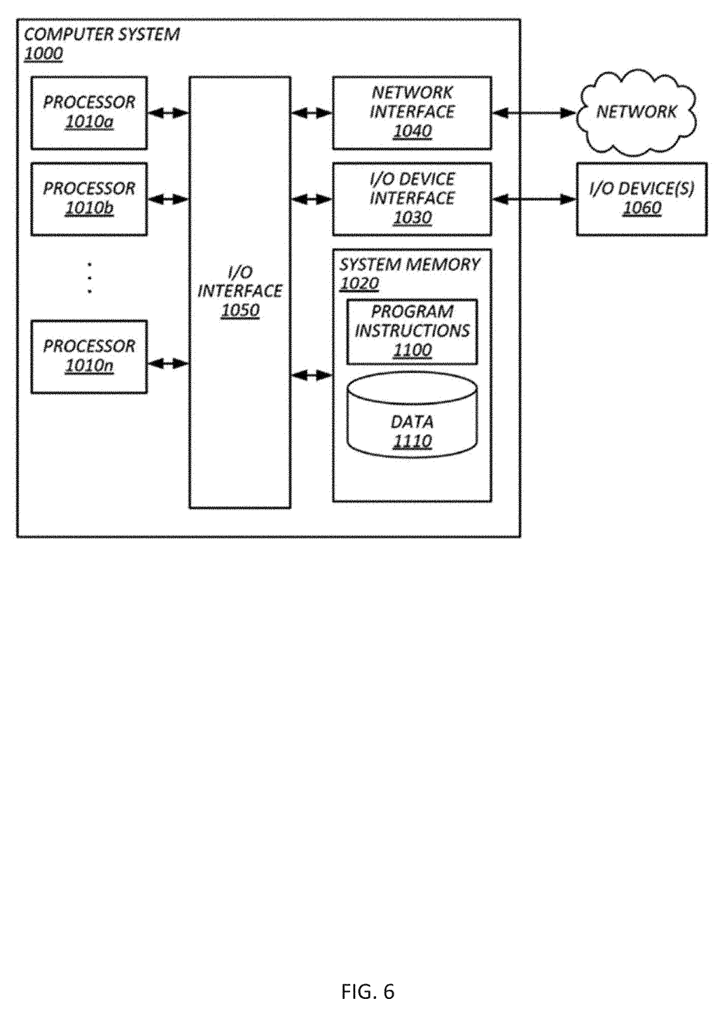

FIG. 6 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,” “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct.

In this patent, to the extent certain U.S. patents, U.S. patent applications, or other materials (e.g., articles) have been incorporated by reference, the text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A method of providing logical access between software development tools and stored content that is otherwise inaccessible to the software development tools, the method comprising: mounting, with one or more processors, a virtual file system to an underlying file system configured to store content on a mount point, wherein: the underlying file system configured to store content is accessible via the mount point, the underlying file system configured to store content has access to data created, edited, or otherwise modified by, using, or within third party software, and source code is not available for the third party software; mapping, with one or more processors, the data to a plurality of files or a plurality of folders accessible with the virtual file system; and logically associating, with one or more processors, the plurality of files or the plurality of folders with the data such that modification of the data in the underlying file system causes modification of at least one of the plurality of files or one of the plurality of folders accessible with the virtual file system.
2. The method of embodiment 1, wherein: the third party software is a compiled or interpreted version of enterprise software encoded in byte code or native machine code; the plurality of files or the plurality of folders accessible with the virtual file system are in a format and location that is accessible and intelligible to a software development tool; the data in the underlying file system is in a format or a location that is inaccessible or unintelligible to the software development tool; the data in the underlying file system comprises: information created from enterprise software created, edited, or modified using a visual programming language; and artifacts associated with the information; and the method further comprises: detecting a modification of the data in the underlying file system; accessing the logical association; and modifying at least one of the plurality of files or one of the plurality of folders accessible with the virtual file system based on the logical association in response to detecting the modification.
3. The method of any of embodiments 1-2, further comprising causing the plurality of files or the plurality of folders to be displayed to a user.
4. The method of any of embodiments 1-3, wherein the data and the virtual file system are stored on separate computing devices.
5. The method of any of embodiments 1-4, further comprising: logically associating the data in the underlying file system with a plurality of artifacts related to the data such that modification of at least one of the plurality of files or one of the plurality of folders modifies the data and at least one of the plurality of artifacts associated with the data.
6. The method of any of embodiments 1-5, wherein the underlying file system configured to store content is a native file system.
7. The method of any of embodiments 1-6, further comprising: accessing the virtual file system with a software development tool; and causing contents of the virtual file system to be displayed within a user interface of the software development tool.
8. The method of any of embodiments 1-7, further comprising: identifying a subset of the data associated by: programmatically adjusting a configuration of the third party software; and selecting portions of the data that change responsive to the programmatic adjustments as the subset, wherein: logically associating comprises mapping the subset of the data to a subset of the plurality of files or a subset of the plurality of folders accessible with the virtual file system.
9. The method of any of embodiments 1-8, further comprising: receiving, from a user, additional data by, using, or within third party software; and after receiving the additional data, creating another file within the virtual file system associated with the additional data without further user input.
10. The method of any of embodiments 1-9, further comprising the step of: receiving, from a user, another file within the virtual file system; creating additional data by, using, or within third party software associated with the other file without additional user input.
11. A method of accessing stored data, comprising the steps of: selecting, with one or more processors, first data stored in an format or location that is unusable or inaccessible by a software development tool; identifying, with one or more processors, second data associated with the first data, the second data being an artifact of a third party software application for which source code is not available or mutable persistent program state of the third party software application; creating, with one or more processors, a first file with a first file name and a second file with a second file name; mapping, with one or more processors, the first file to the first data and the second file to the second data; and writing, with one or more processors, the mapping to a virtual file system, wherein the first data and the second data are stored outside of the virtual file system.
12. The method of embodiment 11, wherein the data is stored in the format that is unusable and the format that cannot be parsed by the software development tool.
13. The method of any of embodiments 11-12, wherein the first data is created by the use of third party software, and the second data is metadata that describes the first data.
14. The method of any of embodiments 11-13, further comprising: creating the first data based on a user's input into the third party software; and storing the first data in a file system accessed by the third party software.
15. The method of any of embodiments 11-14, wherein the selecting or the identifying is performed by programmatically varying a state of the third party software and selecting subsets of information in a data repository that change in response to the programmatic variation.
16. A non-transitory computer-readable medium having computer-executable instructions stored thereon which, when executed by one or more processors effectuate operations comprising: mounting, with one or more processors, a virtual file system to an underlying file system configured to store content on a mount point, wherein: the underlying file system configured to store content is accessible via the mount point, the underlying file system configured to store content has access to data created, edited, or otherwise modified by, using, or within third party software, and source code is not available for the third party software; mapping, with one or more processors, the data to a plurality of files or a plurality of folders accessible with the virtual file system; and logically associating, with one or more processors, the plurality of files or the plurality of folders with the data such that modification of the data in the underlying file system causes modification of at least one of the plurality of files or one of the plurality of folders accessible with the virtual file system.
17. The medium of embodiment 16, wherein: the plurality of files or the plurality of folders accessible with the virtual file system are in a format and location that is accessible and intelligible to a software development tool; and the data in the underlying file system is in a format or a location that is inaccessible or unintelligible to the software development tool.
18. The medium of any of embodiments 16-17, wherein the third party software is a compiled or interpreted version of enterprise software encoded in byte code or native machine code.
19. The medium of any of embodiments 16-18, wherein the operations comprise: logically associating the first plurality of files or the first plurality of folders with the first data, wherein modification of the at least one of the first plurality of files or one of the first plurality of folders modifies the first data.
20. The medium of any of embodiments 16-19, wherein the operations comprise: steps for making third party software accessible to software development tools.

1. A method of providing logical access between software development tools and stored content that is otherwise inaccessible to the software development tools, the method comprising:
mounting, with one or more processors, a virtual file system to an underlying file system configured to store content on a mount point, wherein:
the underlying file system configured to store content is accessible via the mount point,
the underlying file system configured to store content has access to data created, edited, or otherwise modified by, using, or within third party software, and
source code is not available for the third party software;
mapping, with one or more processors, the data to a plurality of files or a plurality of folders accessible with the virtual file system; and
logically associating, with one or more processors, the plurality of files or the plurality of folders with the data such that modification of the data in the underlying file system causes modification of at least one of the plurality of files or one of the plurality of folders accessible with the virtual file system.

2. The method of claim 1, wherein:
the third party software is a compiled or interpreted version of enterprise software encoded in byte code or native machine code;
the plurality of files or the plurality of folders accessible with the virtual file system are in a format and location that is accessible and intelligible to a software development tool;
the data in the underlying file system is in a format or a location that is inaccessible or unintelligible to the software development tool;
the data in the underlying file system comprises:
information created from enterprise software created, edited, or modified using a visual programming language; and
artifacts associated with the information; and
the method further comprises:
detecting a modification of the data in the underlying file system;
accessing the logical association; and
modifying at least one of the plurality of files or one of the plurality of folders accessible with the virtual file system based on the logical association in response to detecting the modification.

3. The method of claim 1, further comprising causing the plurality of files or the plurality of folders to be displayed to a user.

4. The method of claim 1, wherein the data and the virtual file system are stored on separate computing devices.

5. The method of claim 1, further comprising:
logically associating the data in the underlying file system with a plurality of artifacts related to the data such that modification of at least one of the plurality of files or one of the plurality of folders modifies the data and at least one of the plurality of artifacts associated with the data.

6. The method of claim 1, wherein the underlying file system configured to store content is a native file system.

7. The method of claim 1, further comprising:
accessing the virtual file system with a software development tool; and
causing contents of the virtual file system to be displayed within a user interface of the software development tool.

8. The method of claim 1, further comprising:
identifying a subset of the data associated by:
programmatically adjusting a configuration of the third party software; and
selecting portions of the data that change responsive to the programmatic adjustments as the subset, wherein:
logically associating comprises mapping the subset of the data to a subset of the plurality of files or a subset of the plurality of folders accessible with the virtual file system.

9. The method of claim 1, further comprising:
receiving, from a user, additional data by, using, or within third party software; and
after receiving the additional data, creating another file within the virtual file system associated with the additional data without further user input.

10. The method of claim 1, further comprising the step of:
receiving, from a user, another file within the virtual file system;
creating additional data by, using, or within third party software associated with the other file without additional user input.

11. A method of accessing stored data, comprising the steps of:
selecting, with one or more processors, first data stored in an format or location that is unusable or inaccessible by a software development tool;
identifying, with one or more processors, second data associated with the first data, the second data being an artifact of a third party software application for which source code is not available or mutable persistent program state of the third party software application;
creating, with one or more processors, a first file with a first file name and a second file with a second file name;
mapping, with one or more processors, the first file to the first data and the second file to the second data; and
writing, with one or more processors, the mapping to a virtual file system, wherein the first data and the second data are stored outside of the virtual file system.

12. The method of claim 11, wherein the data is stored in the format that is unusable and the format that cannot be parsed by the software development tool.

13. The method of claim 11, wherein the first data is created by the use of third party software, and the second data is metadata that describes the first data.

14. The method of claim 11, further comprising:
creating the first data based on a user's input into the third party software; and
storing the first data in a file system accessed by the third party software.

15. The method of claim 11, wherein the selecting or the identifying is performed by programmatically varying a state of the third party software and selecting subsets of information in a data repository that change in response to the programmatic variation.

16. A non-transitory computer-readable medium having computer-executable instructions stored thereon which, when executed by one or more processors effectuate operations comprising:
mounting, with one or more processors, a virtual file system to an underlying file system configured to store content on a mount point, wherein:
the underlying file system configured to store content is accessible via the mount point,
the underlying file system configured to store content has access to data created, edited, or otherwise modified by, using, or within third party software, and
source code is not available for the third party software;
mapping, with one or more processors, the data to a plurality of files or a plurality of folders accessible with the virtual file system; and
logically associating, with one or more processors, the plurality of files or the plurality of folders with the data such that modification of the data in the underlying file system causes modification of at least one of the plurality of files or one of the plurality of folders accessible with the virtual file system.

17. The medium of claim 16, wherein:
the plurality of files or the plurality of folders accessible with the virtual file system are in a format and location that is accessible and intelligible to a software development tool; and
the data in the underlying file system is in a format or a location that is inaccessible or unintelligible to the software development tool.

18. The medium of claim 16, wherein the third party software is a compiled or interpreted version of enterprise software encoded in byte code or native machine code.

19. The medium of claim 16, wherein the operations comprise:
logically associating the first plurality of files or the first plurality of folders with the first data, wherein modification of the at least one of the first plurality of files or one of the first plurality of folders modifies the first data.

20. The medium of claim 16, wherein the operations comprise:
steps for making third party software accessible to software development tools.
